(19) United States
(12) Patent Application Publication
(10) Pub. No.: US 2007/0174256 A1
(43) Pub. Date: Jul. 26, 2007

(54) METHOD FOR AGING AND RESAMPLING OPTIMIZER STATISTICS

(76) Inventors: John Mark Morris, San Diego, CA (US); Timothy Kraus, Carlsbad, CA (US)

Correspondence Address: JAMES M. STOVER;NCR CORPORATION, 1700 SOUTH PATTERSON BLVD, WHQ4, DAYTON, OH, 45479, US

(21) Appl. No.: 11/622,622

(22) Filed: Jan. 12, 2007

Related U.S. Application Data
(60) Provisional application No. 60/758,768, filed on Jan. 13, 2006.

(51) Int. Cl. G06F 17/30

(52) U.S. Cl. 707/3

(57) ABSTRACT

A system and method for use in retrieving rows of data from at least one table in a database system comprising tables of data stored on one or more storage facilities and managed by one or more processing units. A plurality of samples retrieved from a table in the database are maintained in computer memory, the samples associated with age data representing the order in which the samples were retrieved. The number of samples (S) required to be maintained that are representative of the table is calculated. The number of samples (A) to remove from the samples maintained in computer memory is calculated. The A oldest samples are removed from the samples maintained in computer memory. The number of samples (R) to retrieve from the table is calculated. R new samples are retrieved from the table. The R new samples are stored with the samples maintained in computer memory.

### BACKGROUND

Computer systems generally include one or more processors interfaced to a temporary data storage device such as a memory device and one or more persistent data storage devices such as disk drives. Data is usually transferred between the memory device and the disk drives over a communications bus or similar. Once data has been transferred from the disk drive to a memory device accessible by a processor, database software is then able to examine the data to determine if it satisfies the conditions of a query.

In data mining and decision support applications, it is often necessary to scan large amounts of data to include or exclude relational data in an answer set. Where a user query includes more than one input relation it is often necessary to retrieve large amounts of data from the disk drives and to construct intermediate result sets. Much of the intermediate result sets are discarded if the data in the intermediate result sets does not satisfy the conditions of a query.

Queries issued to the database system may be processed with a multitude of possible execution plans. Some execution plans are more cost efficient than other execution plans based on several factors including the number and size of intermediate result sets required to be constructed. Some queries are able to undergo query optimization that can enable dramatic improvements and performance in such database systems. A cost based query optimizer evaluates some or all possible execution plans for a query and estimates the cost of each plan based on resource utilization. The optimizer eliminates costly plans and chooses a relatively low cost plan.

One of the inputs to the optimizer is demographic statistics about the tables referenced in the query. In many database systems the user or database administrator is responsible for gathering the statistics. This human element of control often leads to non existent or inaccurate statistics. Inaccurate statistics occur when the demographics of the table data have significantly changed since statistics were last gathered.

### SUMMARY

Described below is a method for use in retrieving rows of data from at least one table in a database system comprising tables of data stored on one or more storage facilities and managed by one or more processing units. A plurality of samples retrieved from a table in the database are maintained in computer memory, the samples associated with age data representing the order in which the samples were retrieved. The number of samples (S) required to be maintained that are representative of the table is calculated. The number of samples (A) to remove from the samples maintained in computer memory is calculated. The A oldest samples are removed from the samples maintained in computer memory. The number of samples (R) to retrieve from the table is calculated. R new samples are retrieved from the table. The R new samples are stored with the samples maintained in computer memory.

Also described below is a method for periodically retrieving rows of data from at least one table in a database system on expiry of a timer associated with the table. A refresh period (? T2) is calculated to associate with the table. One or more rows of data are retrieved from the table by the above method. The timer associated with the table is reset to expire at a time calculated from the refresh period ? T2.

Further described is a method for generating statistics on a table in a database system. Rows of data are periodically retrieved from the table by the above method. Statistics are generated on the table from the samples maintained in computer memory.

Also described is a method of optimizing queries to a database system comprising tables of data stored on one or more storage facilities and managed by one or more processing units. A user query is received having a plurality of potential execution plans. The cost of one or more of the potential execution plans is estimated based at least partly on statistics generated by the above method. An execution plan is selected from the potential execution plans based at least partly on the estimated cost of one or more of the potential execution plans.

Also described below is a database system comprising one or more tables of data stored on one or more storage facilities and managed by one or more processing units, where the system is configured to obtain samples of data stored in at least one of the tables. The system includes a refresh period (? T1) associated with at least one of the tables, a refresh percentage (P), associated with the table(s), and a timer configured to invoke the obtaining of a sample of data stored in the table(s) at a time calculated as a function of the timer and the refresh period. The system further includes a sampler configured to obtain a sample of data from the table(s) comprising a plurality of rows of the table, the number of rows calculated as a function of the refresh percentage associated with the table(s).

Also described is a method of defining a table in a database system configured to obtain samples of data stored in at least one of the tables. A refresh period (? T1) and a refresh percentage (P) are associated with the table. A timer associated with the table is set to expire at a time calculated from the refresh period (? T1), thereby triggering the obtaining of a sample of data from the table, the size of the sample calculated at least partly from the refresh percentage P.

### BRIEF DESCRIPTION OF THE DRAWINGS

FIG. 1 is a block diagram of an exemplary large computer system in which the techniques described below are implemented.

FIG. 2 is a block diagram of the parsing engine of the computer system of FIG. 1.

FIG. 3 is a flow chart of the parser of FIG. 2.

FIG. 4 is a flow chart showing one technique of sampling data.

FIG. 5 is a flow chart showing a technique for creating a table that supports the technique of FIG. 4.

FIG. 6 is a flow chart showing a technique to perform following a system restart to support the technique of FIG. 4.

FIG. 7 is a flow chart showing a technique of periodic monitoring of tables.

FIG. 8 show example tables.

### DETAILED DESCRIPTION OF DRAWINGS

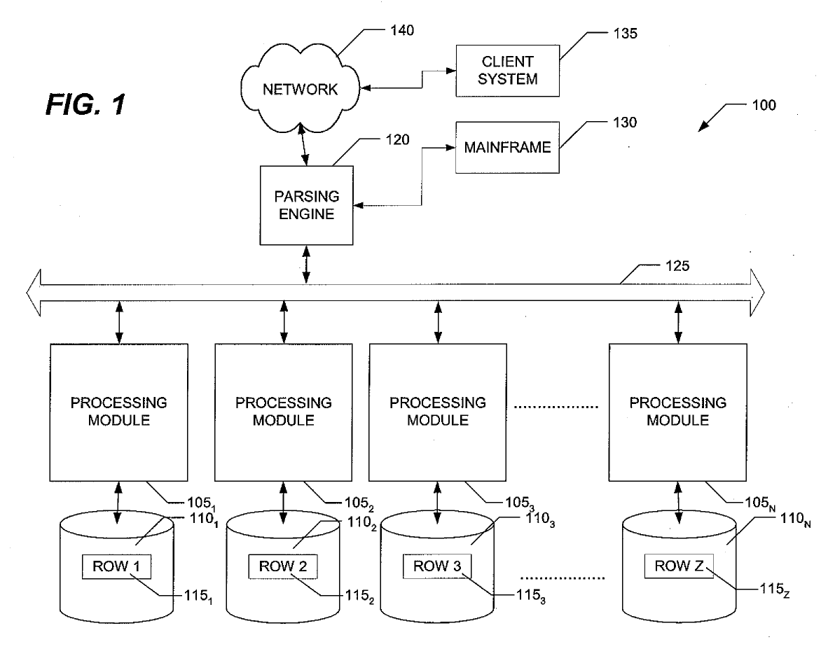

FIG. 1 shows an example of a database system 100, such as a Teradata Active Data Warehousing System available from NCR Corporation. Database system 100 is an example of one type of computer system in which the techniques of aging and resampling optimizer statistics are implemented. In computer system 100, vast amounts of data are stored on many disk-storage facilities that are managed by many processing units. In this example the data warehouse 100 includes a Relational Database Management System (RDMS) built upon a Massively Parallel Processing (MPP) platform.

Other types of database systems, such as object-relational database management systems (ORDMS) or those built on symmetric multi-processing (SMP) platforms, are also suited for use here.

The database system 100 includes one or more processing modules 105_{1 . . . N} that manage the storage and retrieval of data in data storage facilities 110_{1 . . . N}. Each of the processing modules 105_{1 . . . N} manages a portion of a database that is stored in a corresponding one of the data storage facilities 110_{1 . . . N}. Each of the data storage facilities 110_{1 . . . N} includes one or more disk drives.

The system stores data in one or more tables in the data storage facilities 110_{1 . . . N}. The rows 115_{1 . . . Z} of the tables are stored across multiple data storage facilities 110_{1 . . . N} to ensure that the system workload is distributed evenly across the processing modules 105_{1 . . . N}. A parsing engine 120 organizes the storage of data and the distribution of table rows 115_{1 . . . Z} among the processing modules 105_{1 . . . N}. The parsing engine 120 also coordinates the retrieval of data from the data storage facilities 110_{1 . . . N} over network 125 in response to queries received from a user at a mainframe 130 or a client computer 135 connected to a network 140. The database system 100 usually receives queries and commands to build tables in a standard format, such as SQL.

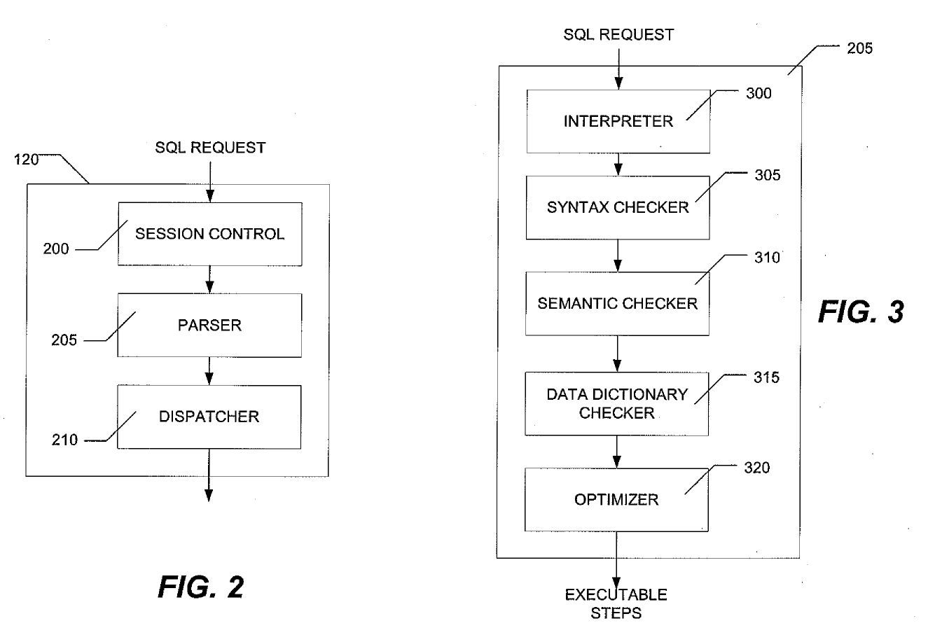

In one example system, the parsing engine 120 is made up of three components: a session control 200, a parser 205, and a dispatcher 210, as shown in FIG. 2. The session control 200 provides a log on and log off function. It accepts a request for authorization to access the database, verifies it, and then either allows or disallows the access.

Once the session control 200 allows a session to begin, a user may submit a SQL request, which is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and the user has the authority to perform the request (block 315). Finally, the parser 205 runs an optimizer (block 320) which develops the least expensive plan to perform the request.

The optimizer has access to statistics on one or more of the tables stored on data storage facilities 110. The statistics to be generated and maintained by the techniques described below include for example min, max, mean, mode, median and range statistics. The system is likely to keep a greater number of statistics on larger tables so as to improve plan selection by the optimizer. The statistics are stored as a series of samples obtained from each table for which statistics are maintained. The raw samples of table data are associated with age data representing the order in which the samples were retrieved. The age data is represented by any one of a number of suitable techniques. One example is the use of a circular list having head and tail pointers. Other examples include the use of a queue or the storing of the raw samples in a database table in which individual rows of the table represent respective raw samples and each row of the table includes age data representing the date or time that the samples were retrieved.

The techniques described below attempt to remove the direct human dependency for statistics gathering. The techniques are designed to periodically refresh statistics so that the statistics are always fresh without creating large spikes of resource consumption for statistics gathering. Each table for which statistics is to be gathered is typically associated with a statistics refresh period ? T1. A timer is also associated with the table that is set to invoke the obtaining of samples of data at a time of T0+? T1. This means that raw samples from the table will be gathered periodically and the interval is specified by ? T1. Each table for which statistics is to be gathered is also associated with a refresh percentage P. When discarding old samples from the collection of raw sample data, the refresh percentage P specifies the percentage of raw samples to be discarded and replaced with new samples.

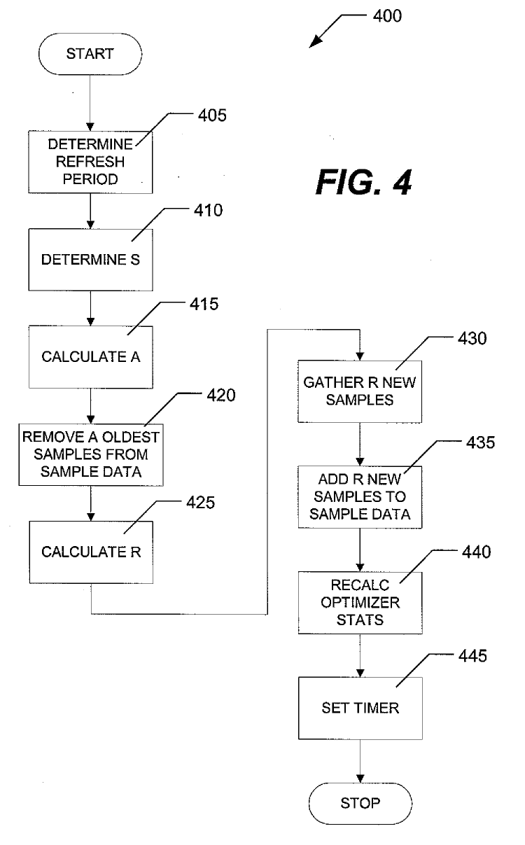

FIG. 4 illustrates one technique for gathering raw samples of data from a table in a database system. The technique of gathering raw samples from a table commences with a new refresh period ? T2 being determined 405. Each table has associated with it an activity rate which gives an indicator of the number of inserts, updates and/or deletes that have been made to the table. An increased activity rate for a table results in a reduced refresh period ? T2. The new refresh period is determined or calculated by a weighted function of activity rates over a series of previous intervals.

An example of such a weighted function to determine the refresh period is:

$$Δ T 2 = \frac{c \cdot 0.01}{R} \qquad ( 1 )$$

In equation (1) above, c represents the table cardinality and R is the weighted activity rate. This example function is intended to set a refresh period over which the table would be expected to experience a magnitude of changes of approximately one percent (1%) of the rows in the table.

An example of a weighted activity rate R covering three (3) previous intervals would be:

$$R = \frac{W 1 \cdot R 1 + W 2 \cdot R 2 + W 3 \cdot R 3}{W 1 + W 2 + W 3} \qquad ( 2 )$$

In equation (2) above, R1, R2, and R3 are the activity rates observed during the previous three (3) intervals, and W1, W2, and W3 are the respective weights. Example weights might be chosen as W1=4, W2=2, and W3=1, in order to give a substantial weight to the previous interval, less substantial weight to the interval two (2) periods earlier, and even less substantial weight to the interval three (3) periods earlier.

Each table requires a number of samples S to provide a statistically significant sample on which to generate the required optimizer statistics. The technique determines 410 the required number of samples S. In one form the value of S is simply based on a previous interval S′ or inherited from a previous interval. In other circumstances the value of S will be calculated by a system function taking as input the table cardinality.

An example of such a function is:

$$S = \{ \begin{matrix}c / 10 & for 0 < c \leq 1 \text{,} 000 \text{,} 000 \\ c \cdot {10}^{2 - ( ( log c ) / 2 )} & for 1 \text{,} 000 \text{,} 000 < c < ∞\end{matrix} \qquad ( 3 )$$

The log in equation 3 above is the base 10 logarithm function. The value of c is any non-negative integer greater than zero.

The function shown in equation (3) is intended to provide a sample size equal to one tenth ( 1/10) of the table cardinality, for table cardinalities not exceeding one million rows (1,000,000), and sample sizes equal to smaller fractions of the table cardinality for progressively larger table cardinalities in excess of one million (1,000,000) rows.

In other forms a user or database administrator provides a user defined function that replaces the system function. For example, a database administrator might define a replacement function providing a sample size equal to one one hundredth ( 1/100) of the table cardinality for table cardinalities not exceeding ten thousand (10,000) rows, and sample sizes equal to smaller fractions of the table cardinality for progressively larger table cardinalities in excess of ten thousand (10,000) rows.

The table activity rate is compared with a threshold activity rate. If the table activity rate is greater than a threshold activity rate then a new value of S is calculated that is associated with the table, otherwise the value of S is inherited from a previous interval S′. An example of a threshold activity rate that could be used for this purpose is 0 rows per second, which would result in the recalculation of S whenever any rows have changed.

The next step is to calculate 415 the number of samples to remove from the samples maintained in computer memory from which the statistics for the table are generated. The tagging of such samples and removal of the samples is known as “aging” the samples and the number of samples to age (A) in one form is calculated by multiplying the number of samples required S by the refresh percentage P of the table. Once the number of samples to age A has been calculated, the oldest samples are removed 420 from the sample data. The number of samples removed from the stored samples is the number A calculated in step 415 above. If the value of A calculated in 415 is greater than the value of S calculated in step 410 then all samples are aged and removed.

The next step is to calculate 425 the number of samples R to gather from the table. One example calculation is:

$$R = \{ \begin{matrix}S - ( {S}^{′} - A ) & for A < {S}^{′} \\ S & for A \geq {S}^{′}\end{matrix} \qquad ( 4 )$$

S′ is the number of samples that were required in the previous interval.

Once the value of R is calculated, R new samples are then gathered or retrieved from the table and the R new samples are added 435 to the samples representing the table that are already maintained in computer memory.

The optimizer statistics are then recalculated 440 based on the new sample data and maintained in computer memory ready for access by the optimizer.

The timer associated with the table is then set 445 to expire at the current time ? T2, the value of ? T2 having been determined in step 405 above. The expiry of the timer invokes the data gathering or sampling process.

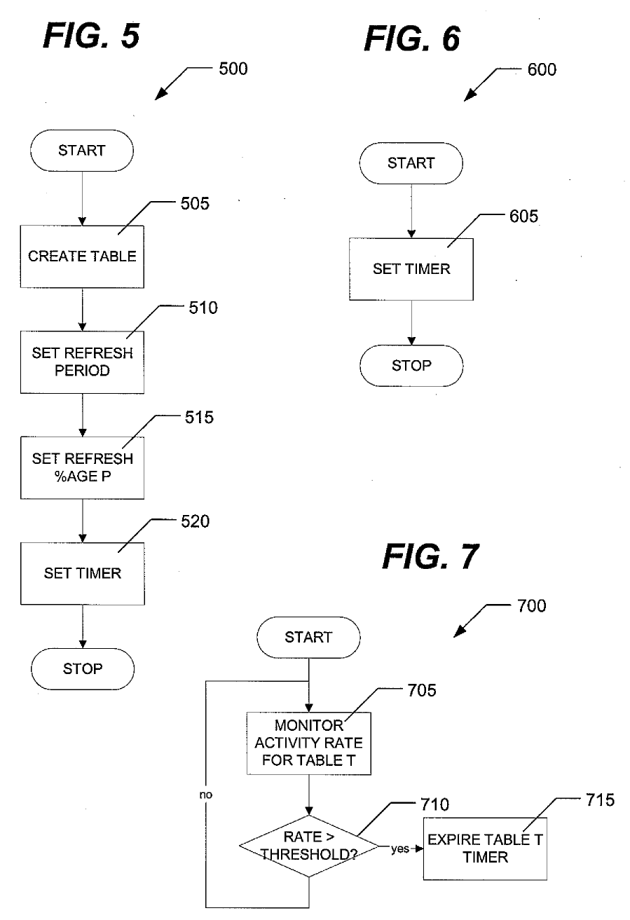

FIG. 5 shows one technique 500 for creating a table in a manner that will support the data gathering techniques described above. The first step is to create 505 a table in the database system in the usual manner. An initial refresh period ? T1 is set 510. This initial refresh period is either determined by system default or could be defined by the user or database administrator.

A refresh percentage P is also set 515 by system default or user defined by either a user or a database administrator.

A timer associated with the table is then set 520 to expire at a time of T0 representing an initial time T0+? T1, where ? T1 represents the initial refresh period. This technique ensures that each table for which statistics are required are configured so that raw samples are obtained periodically from the table.

FIG. 6 illustrates a preferred method following a system restart to ensure or facilitate the gathering of raw samples by the techniques described above. Following a system restart 600 the timer associated with each table is set 605 to an initial period T0. The preferred time for each timer is the last known point before the system shut down or crash.

A further technique shown in FIG. 7 facilitates the periodic gathering of statistics. In the technique 700 the database system periodically monitors the activity rate for each table T in the database for which statistics are periodically gathered. Where an activity rate for example the rate of inserts, updates and deletes exceeds a threshold associated with that table 710, the timer associated with the table is expired 715 thereby triggering the data gathering techniques described above.

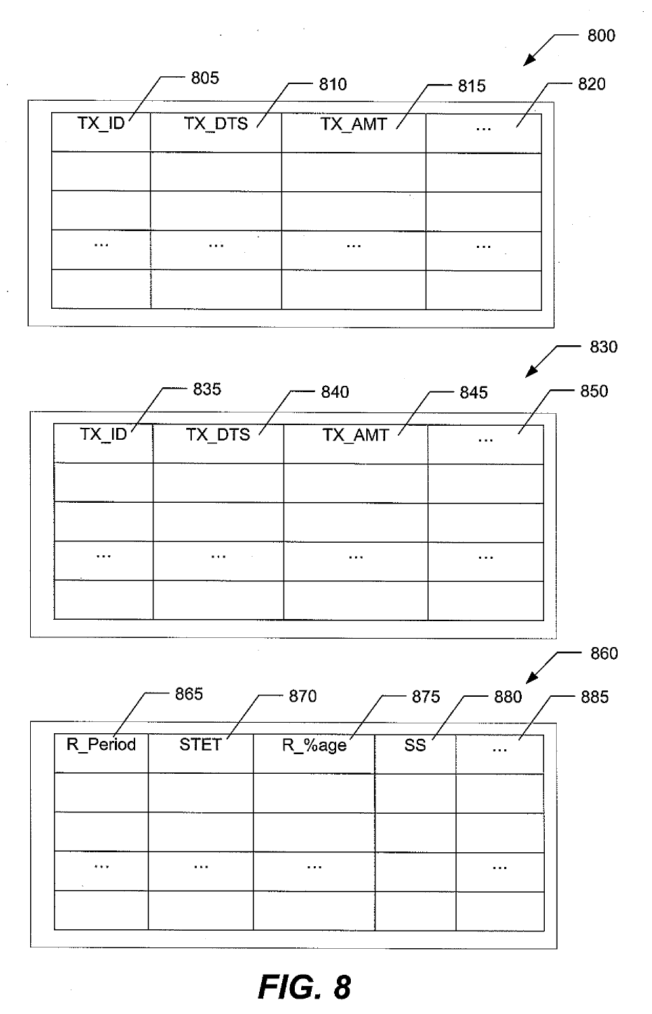

FIG. 8 illustrates a typical table 800 stored in a database system. Database table 800 is an example of transaction data. Transaction data typically records transactional events that are routine in the life of a business such as retail purchases by customers, call-detail records, bank deposits, bank withdrawals and insurance claims. Table 800 includes a transaction identifier (TX_ID, column 805), a transaction date-time stamp indicating when a particular transaction took place (TX_DTS, column 810) and the value or amount of the transaction (TX_AMT, column 815). The table 800 could include further columns 820.

Rows sampled from table 800 are normally stored in a new sub-table 830 of table 800. In the Teradata system, sub-tables are used for various purposes including the storage of index information and are usually stored adjacent to the table. Sub-table 830 includes the same fields as table 800 namely a transaction identifier (TX_ID, column 835), a transaction date-time stamp (DX_DTS, column 840) and the value or amount of the transaction (TX_AMT, column 845). The sub-table 830 could include further columns 850.

The various metrics that are stored associated with table 800 are typically stored in new columns in the Teradata system table 860 named “TVM” which is short for “tables, views and macros”. The purpose of the TVM table is to record and maintain official system information about the various tables that exist in the system. The TVM table 860 could include new columns such as a refresh period (R_Period, column 865), scheduled timer expiration time (STET, column 870), a refresh percentage (R_% age, column 875) and a sample size (SS, column 880) as well as all the usual columns already present in the TVM indicated at 885.

The above techniques provide an automatic method for gathering and aging optimizer statistics that keep statistics fresh, eliminates non existent or out of date statistics due to human fallibility, and that operates without resource utilization spikes for statistics gathering.

The text above describes one or more specific embodiments of a broader invention. The invention also is carried out in a variety of alternative embodiments and thus is not limited to those described here. Those other embodiments are also within the scope of the following claims.

We claim:

1. A method for use in retrieving rows of data from at least one table in a database system comprising tables of data stored on one or more storage facilities and managed by one or more processing units, the method comprising:
maintaining in computer memory a plurality of samples retrieved from a table in the database, the samples associated with age data representing the order in which the samples were retrieved;
calculating the number of samples (S) required to be maintained that are representative of the table;
calculating the number of samples (A) to remove from the samples maintained in computer memory;
removing A of the oldest samples from the samples maintained in computer memory;
calculating the number of samples (R) to retrieve from the table;
retrieving R new samples from the table; and
storing the R new samples with the samples maintained in computer memory.

2. The method of claim 1, where the step of calculating the number of samples (S) further comprises:
calculating an activity rate associates with the table;
comparing the table activity rate with a threshold activity rate; and
if the table activity rate is greater than the threshold activity rate then calculating a new S value to associate with the table.

3. The method of claim 1, where the new S value is calculated at least partly from the table cardinality.

4. The method of claim 1 where the new S value is calculated at least partly by a user defined function.

5. The method of claim 1 where the table is associated with a refresh percentage (P), the number of samples (A) calculated at least partly by a function of S and P.

6. A method for periodically retrieving rows of data from at least one table in a database system on expiry of a timer associated with the table, the method comprising:
calculating a refresh period (? T2) to associate with the table;
retrieving one or more rows of data from the table by the method of claim 1; and
resetting the timer associated with the table to expire at a time calculated from the refresh period ? T2.

7. A method for generating statistics on a table in a database system, the method comprising:
periodically retrieving rows of data from the table by the method of claim 1; and
generating statistics on the table from the samples maintained in computer memory.

8. A method of optimizing queries to a database system comprising tables of data stored on one or more storage facilities and managed by one or more processing units, the method comprising:
receiving a user query having a plurality of potential execution plans;
estimating the cost of one or more of the potential execution plans based at least partly on statistics generated by the method of 7; and
selecting an execution plan from the potential execution plans based at least partly on the estimated cost of one or more of the potential execution plans.

9. A database system comprising one or more tables of data stored on one or more storage facilities and managed by one or more processing units, where the system is configured to obtain samples of data stored in at least one of the tables, where the system includes:
a refresh period (? T1) associated with at least one of the tables;
a refresh percentage (P), associated with the table(s);
a timer configured to invoke the obtaining of a sample of data stored in the table(s) at a time calculated as a function of the timer and the refresh period; and
a sampler configured to obtain a sample of data from the table(s) comprising a plurality of rows of the table, the number of rows calculated as a function of the refresh percentage associated with the table(s).

10. The database system of claim 9, where the refresh period is determined by system default.

11. The database system of claim 9, where the refresh period is user defined.

12. The database system of claim 9 where the refresh percentage is determined by system default.

13. The database system of claim 9 where the refresh percentage is user defined.

14. A method of defining a table in a database system configured to obtain samples of data stored in at least one of the tables, the method comprising:
associating with the table a refresh period (? T1);
associating with the table a refresh percentage (P); and
setting a timer associated with the table to expire at a time calculated from the refresh period (? T1), thereby triggering the obtaining of a sample of data from the table, the size of the sample calculated at least partly from the refresh percentage P.

15. The method of claim 14 further comprising the step of determining the refresh period by system default.

16. The method of claim 14 further comprising the step of enabling a user to define the refresh period.

17. The method of claim 14 further comprising the step of determining the refresh period by system default.

18. The method of claim 14 further comprising the step of enabling a user to define the refresh percentage.
